(19) United States
(12) Patent Application Publication
(10) Pub. No.: US 2005/0002060 A1
(43) Pub. Date: Jan. 6, 2005

(54) System for printing image data stored in a plurality of image storage devices and method of printing image data thereof

(75) Inventor: Tae-hoi Do, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/857,984

(22) Filed: Jun. 2, 2004

(30) Foreign Application Priority Data
Jul. 5, 2003 (KR) 2003-45481

(51) Int. Cl. G06K 15/02; H04N 1/387; G06F 3/12

(52) U.S. Cl. 358/1.17; 358/450; 358/1.18

(57) ABSTRACT

A system for printing image data and a method of printing image data thereof capable of printing image data stored in a plurality of image storage devices. The printing system includes a plurality of image storage devices storing at least one image data, and a printing device receiving and storing at least one image data from one of the plurality of image storage devices, receiving and storing at least one image data from at least another of the plurality of image storage devices, and rearranging and printing the stored image data on a specified position of a printing paper.

### CROSS-REFERENCE TO RELATED APPLICATIONS

This application claims benefit under 35U.S.C. § 119 from Korean Patent Application No. 2003-45481, filed on Jul. 5, 2003, the disclosure of which is incorporated herein by reference.

### BACKGROUND OF THE INVENTION

1. Field of the Invention

The present invention relates to a system for printing image data stored in a plurality of image storage devices and a method of printing image data thereof, and more particularly, to a system for printing image data stored in a plurality of image storage devices and a method of printing image data thereof, which can receive image data stored in a plurality of image storage devices, rearrange and print the image data on a specified position of a printing paper.

2. Description of the Related Art

A printing device is a device for receiving data to be printed from a computer or an external storage device, and prints the data on a printing paper. Generally, a printing device may be implemented as an independent printer or one part of a combined appliance that can perform a scanning, printing, copying, etc.

With the development of technology, many special functions have been added to the printing device. Accordingly, a user can use the printing device using the special functions. Also, the user can set many different options according to the special functions.

Despite such diverse special functions, the conventional printing device can only receive and print a plurality of image data from one image storage device. Thus, in order to print various image data from a plurality of image storage devices on a printing paper, the image data subject to printing must be downloaded, which are stored in the respective image storage devices, to a computer, edited using an application program so that the image data can be printed on a printing paper as an edited document, and then printed on the printing paper. This is time-consuming and difficult, and requires a separate driving of a computer.

### SUMMARY OF THE INVENTION

The invention solves the above and/or other drawbacks and problems associated with the conventional printing device arrangement. An aspect of the invention is to provide a system for printing image data and a method of printing image data thereof that can receive the image data subject to printing from a plurality of image storage devices, and print the image data on a printing paper.

Another object of the invention is to provide a system for printing image data and a method of printing image data thereof which can select image data from one of a plurality of image storage devices and print the image data as a background of a printing paper.

To achieve the above aspects and/or other features of the invention, there is provided a printing system having a plurality of image storage devices for storing at least one image data, and a printing device for receiving and storing at least one image data from one of the plurality of image storage devices, receiving and storing at least one image data from at least another of the plurality of image storage devices, and rearranging and printing the stored image data on a specified position of a printing paper.

The printing device includes an interface unit for connecting to at least one of the plurality of image storage devices, a memory unit for storing the image data inputted from the plurality of image storage devices connected thereto, an image processing unit for rearranging the stored image data so that the stored image data can be printed on the specified position of the printing paper, a printing unit, and a control unit for controlling the image processing unit to rearrange the stored data on the specified position of the printing paper, and controlling the printing unit to print the rearranged image data on the printing paper.

In another aspect of the invention, there is provided a printing method of a printing system provided with a plurality of image storage devices and a printing device, comprising receiving and storing at least one image data from one of the plurality of image storage devices, receiving and storing at least one image data from at least another of the plurality of image storage devices, and rearranging and printing the stored image data on a specified position of a printing paper.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a block diagram of a printing system according to an embodiment of the invention;

FIG. 2 is a block diagram of the printing device of FIG. 1;

FIG. 3A is a view of an input unit of FIG. 2;

FIG. 3B is a second view of an input unit of FIG. 2 according to a second embodiment of the invention;

FIG. 4 is a flowchart illustrating an image data printing method according to an embodiment of the invention;

FIG. 5 is a flowchart illustrating an image data printing method according to the second embodiment of the invention;

FIG. 6 is a flowchart illustrating an image data printing method according to a third embodiment of the invention; and

FIG. 7 is a flowchart illustrating an image data printing method according to a fourth embodiment of the invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

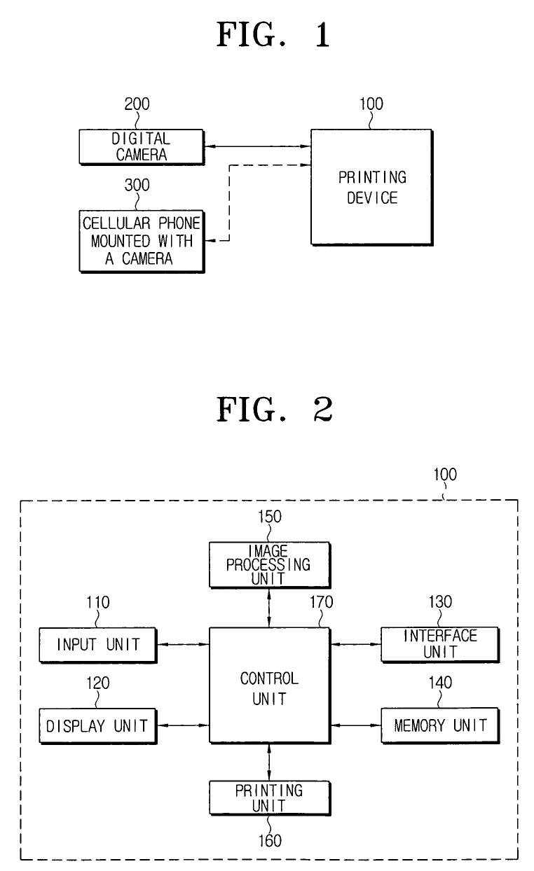

FIG. 1 is a block diagram of a printing system according to the invention and is described hereinbelow.

The printing system includes a printing device 100, a digital camera 200 as an image storage device, and a cellular phone 300 mounted with a camera. The image storage device for storing a still image may be, for example, a digital camcorder, a digital memory card, a DVD, etc. The digital camera 200 is a photographing device for storing and reproducing a picked-up object, and photographs only still images of the object according to the operation of a shutter. Several photographs can be stored in accordance with the capacity of a recording medium of the digital camera. The cellular phone 300 mounted with a camera is a cellular phone having an additional function of photographing in addition to its original function of transmitting/receiving audio signals, and photographs a still image of an object desired by a user.

If a printing command is inputted from the printing device 100, the image data subject to printing is downloaded from the initially connected digital camera 200 to the printing device 100 under the control of the printing device 100 to be temporarily stored. After a disconnection of the digital camera 200 from the printing device 100, the image data subject to printing is downloaded from the next-connected cellular phone 300 mounted with a camera to the printing device 100. The printing device 100 rearranges the image data in accordance with the number of images subject to printing set by a user, and prints the rearranged image data on a printing paper. As a result, image data stored in the digital camera 200 and the cellular phone 300 are printed on a sheet of printing paper.

FIG. 2 is a block diagram of a printing device of FIG. 1 according to an aspect of the invention and is described hereinbelow.

The printing device 100 comprises an input unit 110, a display unit 120, an interface unit 130, a memory unit 140, an image processing unit 150 and a printing unit 160.

The input unit 110 is provided with a plurality of input keys for inputting user commands. The user commands include a printing command, a command for selecting image data subject to printing, a command for setting a multi-printing function, a command for setting the number of images subject to printing, a command for setting a background, a command for selecting background image data, etc. If a corresponding command is inputted through the input unit 110, the printing device 100 operates accordingly.

The display unit 120 displays user selection menus and operation status information of the printing device under the control of a control unit 170. The user can input the user commands through the input unit 110 with reference to information displayed on the display unit 120. The user selection menus includes a menu for setting the number of images subject to printing, a menu for setting a background, a menu for setting the number of images for each image storage device, etc. The operating status information of the printing device includes a message for exchanging the image storage devices, image data list information, etc.

The interface unit 130 is connected with the image storage devices that provide the image data subject to printing. The interface unit 130 preferably comprises a USB (Universal Serial Bus) port. Through the interface unit 130, various kinds of printing-related signals and information, image data subject to printing and background image data are transmitted between the printing device 100 and the image storage devices. The printing-related signals include an image data transmission request signal, an image data absence signal, an image data list information request signal, etc. The printing-related information may be image data list information.

The memory unit 140 includes a non-volatile memory for storing various kinds of programs required for implementing the function of the printing device 100, and a volatile memory for temporarily storing various kinds of data generated while the control unit 170 performs the programs. In the volatile memory of the memory unit 140, the image data transmitted from the image storage devices are stored. In addition, the image data rearranged through the image processing unit 150 or composited image data are temporarily stored in the volatile memory of the memory unit 140 before they are printed through the printing unit 160.

The image processing unit 150 performs the rearrangement of the image data subject to printing, which are stored in the memory unit 140, so that the image data subject to printing are printed on a specified position of the printing paper. At this time, the control unit 170 controls the image processing unit 150 on the basis of the command for setting the number of images subject to printing that is inputted through the input unit 110. If the background setting command is inputted through the input unit 110, the image processing unit 150 performs the rearrangement of the image data and a composition of the rearranged image data and the background image data under the control of the control unit 170.

The printing unit 160 performs the printing of the rearranged image data subject to printing or rearranged and composited image data subject to printing under the control of the control unit 170.

The control unit 170 generally controls the printing device 100. The control unit 170 controls the internal components of the printing device 100 in accordance with the user commands inputted through the input unit 110 and the printing-related signals and information transmitted through the interface unit 130.

If the printing command is inputted, the control unit 170 transmits the image data transmission request signal to the image storage device connected through the interface unit 130. Accordingly, the image data in the image storage device is transmitted to the printing device 100.

When the image data is transmitted and stored according to the image data transmission request signal, the control unit 170 judges whether the number of image data presently stored is equal to the number of images subject to printing. If they are not equal to each other, the control unit 170 transmits the image data transmission request signal. If they are equal to each other, the control unit 170 rearranges the stored image data by controlling the image processing unit 150.

When the initially connected image storage device is disconnected from the control unit and a second image storage device is connected thereto, the control unit 170 transmits the image data transmission request signal to the second image storage device.

When the user sets the number of images per image storage device, the control unit 170 judges whether the number of image data presently stored is equal to the number of images per image storage device set by the user. If the number of images per image storage device are not equal to each other, the control unit 170 transmits an image data transmission request signal. If the number of images per image storage device are equal to each other, the control unit 170 controls the display unit 120 to display the image storage device exchange message or rearranges the stored image data by controlling the image processing unit 150.

When the user selects image data subject to printing in accordance with the image data list information in the image storage device, the control unit 170 judges whether the selected image data subject to printing are all stored in the memory unit 140. If the selected image data subject to printing are not all stored in the memory unit, the control unit 170 transmits the image data transmission request signal. If the selected image data subject to printing are all stored in the memory unit, the control unit 170 judges whether the number of image data presently stored is equal to the number of images subject to printing.

When the number of images per image storage device are not equal to each other, the control unit 170 transmits an image data transmission request signal. When the number of images per image storage device are equal to each other, the control unit 170 controls the display unit 120 to display the image storage device exchange message or rearranges the stored image data by controlling the image processing unit 150. Also, if the initially connected image storage device is disconnected from the control unit and the second image storage device is connected thereto in the case that the user selects the image data subject to printing in accordance with the image data list information in the image storage device, the control unit 170 transmits the image data list information request signal to the second image storage device.

If the background printing function is set, the control unit 170 discriminately stores the background image data and the image data subject to printing in the memory unit 140. When the storage of the image data subject to printing is completed, the control unit 170 controls the image processing unit 150 so that the image data subject to printing are rearranged and the rearranged image data and the background image data are composited.

When the rearrangement or the composition of the image data is completed, the control unit 170 controls the printing unit 160 to print the rearranged or composited image data.

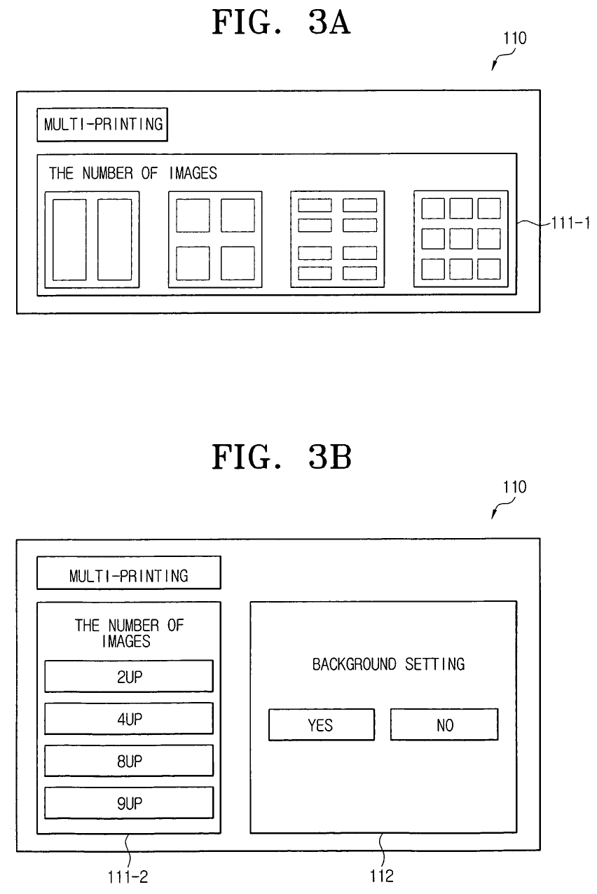

FIG. 3A is a view of the input unit 110 of FIG. 2 and FIG. 3B is a view of the input unit of FIG. 2 according to a second aspect of the invention. In FIGS. 3A and 3B, the display unit and the input unit are applied to the same TSP (Touch Screen Panel).

In FIG. 3A, when the user sets a multi-printing function among special functions, a menu 111-1 for setting the number of images subject to printing is displayed. The user can set the number of images subject to printing using this menu. In FIG. 3A, the number of images subject to printing can be selected as any one of 2, 4, 8 and 9.

In FIG. 3B, when the user sets the multi-printing function, a menu 112 for setting a background as well as a menu 111-2 for setting the number of images subject to printing is displayed. The user can set the number of images subject to printing using this menu and determine whether to set the background. In FIG. 3B, the number of images subject to printing can be selected as any one of 2, 4, 8 and 9 in the same manner as in FIG. 3A.

Hereinafter, different methods of printing image data are explained with reference to FIGS. 1 and 2. In the following aspects of the invention, the number of images subject to printing is set to 9. Also, it is assumed that the printing device 100 is initially connected to the digital camera 200, and after specified image data is transmitted, the printing device is connected to the cellular phone 300 mounted with a camera to receive the image data.

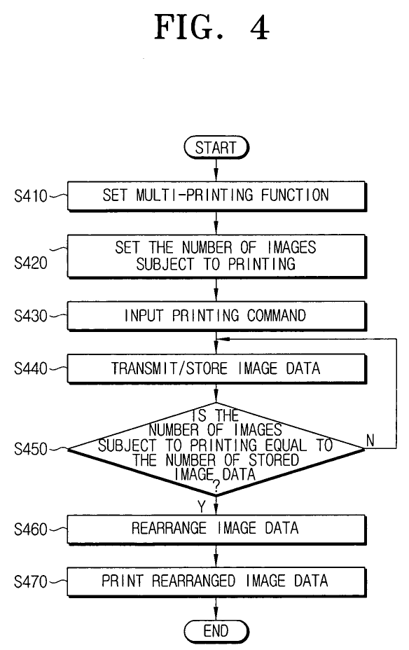

FIG. 4 is a flowchart illustrating the image data printing method according to an aspect of the invention, and is described hereinbelow.

Five image data, i.e., image data 1-1 through 1-5, are stored in a memory (not illustrated) of the digital camera 200, and four image data, i.e., image data 2-1 to 2-4, are stored in a memory (not illustrated) of the cellular phone 300 mounted with a camera.

In operation S410, a user sets the multi-printing function among the special functions. In operation S420, the number of images subject to printing, which is an option of the multi-printing function, is set. After setting the multi-printing function, the user inputs a printing command, in operation S430. The control unit 170 transmits an image data transmission request signal to the digital camera 200, and the image data 1-1 is transmitted from the memory of the initially connected digital camera 200 to the printing device 100. In operation S440, the transmitted image data 1-1 is stored in the memory unit 140 through the interface unit 130. In operation S450, the control unit 170 judges whether the number of image data presently stored in the memory unit 140 is equal to the number of images subject to printing. If the number of image data stored in the memory unit 140 is not equal to the number of images subject to printing, the control unit 170 transmits an image data transmission request signal to the digital camera 200. Accordingly, the image data 1-2 is transmitted to the printing device 100. This process is repeated until the number of image data stored in the memory unit 140 becomes equal to the number of images subject to printing.

Since the number of images subject to printing is 9 and the number of image data stored in the digital camera 200 is 5, no image data remains in the digital camera 200 even if the control unit 170 transmits the image data transmission request signal to the digital camera 200 after the image data 1-5 is stored in the memory unit 140. Accordingly, the digital camera 200 transmits an image data absence signal to the control unit 170. In this case, the control unit 170 controls the display unit 120 to display the image storage device exchange message, and thus the user disconnects the digital camera 200 from the interface unit 130 and connects the cellular phone 300 mounted with a camera to the interface unit 130. The control unit 170 recognizes the connection, and transmits the image data transmission request signal to the cellular phone 300 mounted with a camera, so that the image data 2-1 to 2-4 are transmitted to and stored in the printing device 100 in order.

If the number of image data stored in the memory unit 140 is equal to the number of images subject to printing, the control unit 170 controls the image processing unit 150. The controlled image processing unit 150 processes and rearranges the image data stored in the memory unit 140 so as to print the image data on a printing paper, in operation S460. When the rearrangement of the image data is complete, the control unit 170 controls the printing unit 160 to print the rearranged image data, in operation S470.

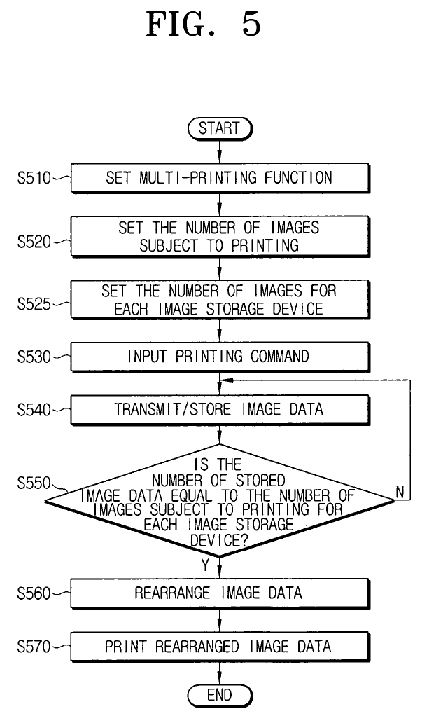

FIG. 5 is a flowchart illustrating the image data printing method according to a second aspect of the invention, and is described hereinbelow.

A plurality of image data are assumed to be stored in the digital camera 200 and the cellular phone 300 mounted with a camera. The image data stored in the digital camera 200 are called image data 1-1, 1-2, 1-3, etc., and the image data stored in the cellular phone mounted with a camera are called image data 2-1, 2-2, 2-3, etc.

The aspect of FIG. 5 includes operations identical to those of the aspect of FIG. 4, except for operations S525 and S550, and thus the detailed explanation of the identical operations will be omitted.

The user sets the multi-printing function, the number of images subject to printing, and the number of images for each image device ( operations S510, S520 and S525). The number of images for each image storage device is set through a menu for setting the number of images for each image storage device. Here, the number of images for each image storage device includes the number of images that the user intends to print in the respective image storage device. It is assumed that the user selects 5 images subject to printing with respect to the digital camera 200 that is the first image storage device, and selects 4 images subject to printing with respect to the cellular phone 300 mounted with a camera that is the second image storage device.

When the user inputs a printing command in operation S530, the printing device 100 receives the image data 1-1 from the digital camera, and stores the received image data 1-1 in the memory unit 140 in operation S540. In operation S550, the control unit 170 judges whether the number of image data transmitted from the first image storage device 200 is equal to the number of images subject to printing that is set with respect to the first image storage device. If the number of image data transmitted from the first image storage device is not equal to the number of images subject to printing, the printing device 100 receives the image data 1-2 from the first image storage device 200. This process is repeated until the number of image data transmitted from the first image storage device 200 becomes equal to the number of images subject to printing that is set with respect to the first image storage device.

Since the number of images subject to printing with respect to the first image storage device is 5, the control unit 170 controls the display unit 120 to display the image storage device exchange message after the image data 1-5 is stored in the memory unit 140. Accordingly, the user disconnects the digital camera 200 that is the first image storage device from the interface unit 130 and connects the cellular phone 300 mounted with a camera to the interface unit 130. In operation S540, the image data 2-1 to 2-4 are transmitted to and stored in the printing device 100 in accordance with the number of images set with respect to the second image storage device.

In operations S560 and S570, nine image data are printed on the printing paper through the rearrangement and printing operation.

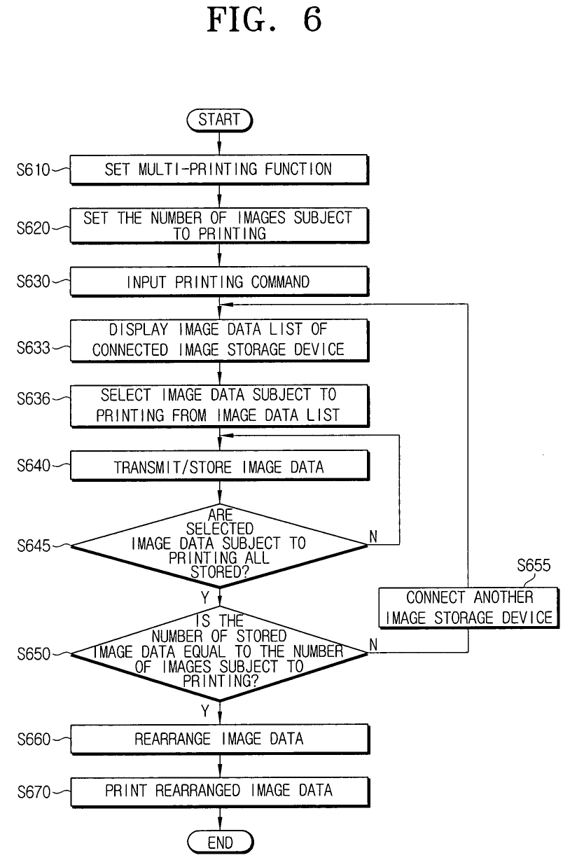

FIG. 6 is a flowchart illustrating the image data printing method according to a third aspect of the invention, and is described hereinbelow.

In the third aspect of the invention, in the same manner as shown in FIG. 5, a plurality of image data are stored in the digital camera 200 and the cellular phone 300 mounted with a camera, and they are called image data 1-1, 1-2, etc., and 2-1, 2-2, etc., respectively.

FIG. 6 includes operations identical to those of the aspect of FIG. 4 except for operations S633, S636, S645 and S655, and thus the detailed explanation of the identical operations will be omitted.

The user sets the multi-printing function in operation S61 0, the number of images subject to printing in operation S620, and inputs a printing command in operation S630. The control unit 170 transmits an image data list request signal to the digital camera 200 that is the first image storage device on the basis of the printing command. According to the image data list request signal, the digital camera 200 transmits the image data list information to the printing device 100, and the transmitted image data list information is displayed through the display unit 120 operation S633. The user selects the image data subject to printing among the displayed image data list in operation S636. It is assumed that the image data 1-1 to 1-5 are selected. When the selection is complete, the selected image data is transmitted from the digital camera 200 to the printing device 100 to be stored in the printing device 100 in operation S640. At this time, the control unit 170 judges whether all the selected image data subject to printing are stored in the memory unit 140 in operation S645. When all the selected image data subject to printing are not stored as a result of judgment, in operation S640, the selected image data are transmitted from the digital camera 200 to the printing device 100 to be stored in the printing device 100 until all the selected image data are transmitted and stored.

When all the selected image data subject to printing are stored in operation S650, the control unit 170 judges whether the number of stored image data is equal to the number of images subject to printing. If the number of stored image data is not equal to the number of images subject to printing, the control unit 170 controls the display unit 120 to display the image storage device exchange message. Accordingly, the user disconnects the digital camera 200 from the interface unit 130 and connects the cellular phone 300 mounted with a camera to the interface unit 130.

When the control unit 170 recognizes that the first image storage device 200 is disconnected and the second image storage device is connected, the control unit 170 transmits the stored image data list request signal to the cellular phone 300 mounted with a camera that is the second image storage device. According to the image data list request signal in operation S633, the cellular phone 300 mounted with a camera transmits the image data list information to the printing device 100, and the transmitted image data list information is displayed through the display unit 120. In operation S636, the user selects the image data subject to printing among the displayed image data list. It is assumed that the image data 2-1 to 2-4 are selected. When the selection is complete, the printing device 100 receives and stores the image data 2-1 to 2-4 in operation S640.

The number of images is 9. When the image data 1-1 to 1-5 and the image data 2-1 to 2-4 are transmitted and inputted, the image data stored under the control of the control unit 170 are printed on the printing paper through the rearrangement and printing operation in operations S660 and S670.

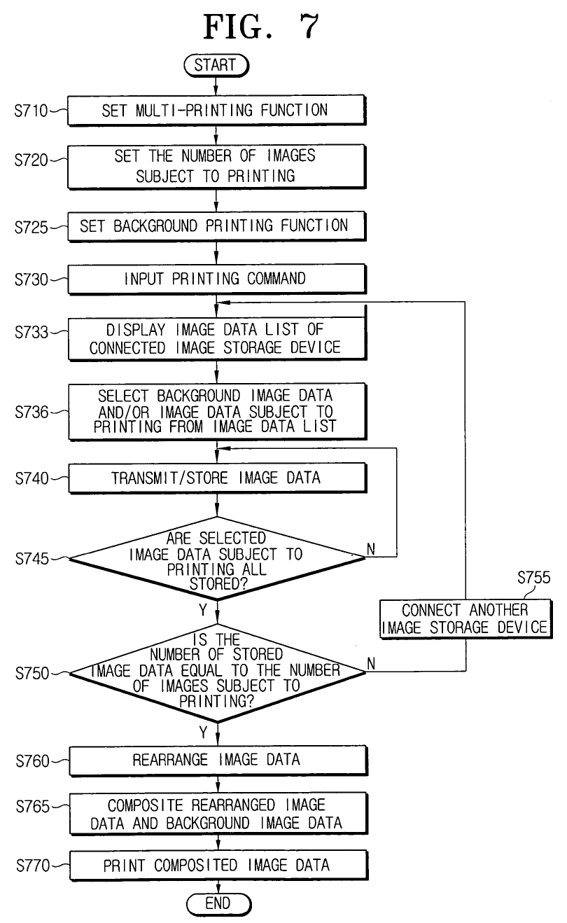

FIG. 7 is a flowchart illustrating the image data printing method according to a fourth aspect of the invention, and is described hereinbelow.

In the fourth aspect of the invention, in the same manner as shown in FIG. 5, a plurality of image data are stored in the digital camera 200 and the cellular phone 300 mounted with a camera, and they are called image data 1-1, 1-2, etc., and 2-1, 2-2, etc., respectively.

FIG. 7 includes operations identical to those of the aspect of FIG. 6 except for operations S725, S736, S765 and S770, and thus the detailed explanation of the identical operations will be omitted.

The user sets the multi-printing function and the number of images subject to printing in operations S710 and S720, sets a background printing function in operation S725, and inputs a printing command in operation S730. The control unit 170 transmits an image data list request signal to the digital camera 200 that is the first image storage device on the basis of the printing command. According to the image data list request signal, the digital camera 200 transmits the image data list information to the printing device 100, and the transmitted image data list information is displayed through the display unit 120 in operation S733.

The user selects the background image data and the image data subject to printing among the displayed image data list in operation S736. At this time, the user may not select the background image data among the displayed image data list, or may select the background image data from the image data list of the next image storage device. When the selection of the background image data and/or the image data subject to printing is complete, the selected image data is transmitted from the digital camera 200 to the printing device 100 to be stored in the printing device 100 in operation S740. At this time, the control unit 170 judges whether all the selected image data subject to printing are stored in the memory unit 140 in operation S745, and the selected image data are transmitted from the digital camera 200 to the printing device 100 to be stored in the printing device 100 until all the selected image data are transmitted and stored on the basis of a result of judgment in operation S740.

Further, on the basis of the result of judgment, the control unit 170 judges whether the number of image data presently stored is equal to the number of images subject to printing in operation S750. The printing device 100, on the basis of this judgment, receives the selected image data subject to printing and/or the background image data from the cellular phone 300 mounted with a camera that is the second image storage device, and stores the received image data in operation S740.

If all the image data subject to printing are received and stored in the printing device, the image data subject to printing are rearranged through the image processing unit 150 under the control of the control unit 170 in operation S760. The rearranged image data and the background image data are composited through the image processing unit 150 in operation S765. The composited image data is printed on the printing paper in operation S770.

In the aspects described above, the image data are read out from the image storage device under the control of the printing device 100. However, the image data may be transmitted to the printing device under the control of the image storage device.

Also, in the aspects as described above, the image data are received from two image storage devices, i.e., from the digital camera 200 and the cellular phone 300 mounted with a camera, but it is apparent that the invention can be practiced irrespective of the number of image storage devices.

Also, in the aspects as described above, the printing device 100 is provided with an interface unit, and image storage devices are sequentially connected to the interface unit. However, two or more interface units may be provided, and two or more image storage devices may simultaneously be connected to the interface units.

As described above, according to the printing system and the image data printing method thereof according to the invention, the image data stored in a plurality of image storage devices can respectively be received and printed on a single printing paper, the waste of printing paper can be reduced. Also, in the case that the image data stored in the plurality of image storage devices are printed on a printing paper using the existing printing method, it is required to edit images using an application program of a computer. However, the invention does not require such an editing work.

Although a few embodiments of the present invention have been shown and described, it would be appreciated by those skilled in the art that changes may be made in this embodiment without departing from the principles and spirit of the invention, the scope of which is defined in the claims and their equivalents.

1. A printing system comprising:
a plurality of image storage devices storing at least one image data; and
a printing device receiving and storing at least one image data from one of the plurality of image storage devices, receiving and storing at least one image data from at least another of the plurality of image storage devices, and rearranging and printing the stored image data on a specified position of a printing paper.

2. The printing system as claimed in claim 1, wherein the printing device comprises:
an interface unit connecting to at least one of the plurality of image storage devices;
a memory unit storing the image data inputted from the plurality of image storage devices connected thereto;
an image processing unit rearranging the stored image data so that the stored image data is printable on the specified position of the printing paper;
a printing unit; and
a control unit controlling the image processing unit to rearrange the stored data on the specified position of the printing paper, and controlling the printing unit to print the rearranged image data on the printing paper.

3. The printing system as claimed in claim 2, wherein the printing device further comprises an input unit provided with a control to set the number of images subject to printing to be printed on the printing paper; and
wherein the control unit controls the image processing unit to rearrange the image data stored in the memory unit on the specified position according to the number of images subject to printing.

4. The printing system as claim in claim 3, wherein the input unit further comprises a background image data selection control for printing one of the image data stored in one of the plurality of image stored device; and
wherein the control unit controls the image processing unit to composite the background image data selected by the background image data selection control and the image data based on the number of images subject to printing.

5. A printing method of a printing system provided with a plurality of image storage devices and a printing device, comprising:
receiving and storing at least one image data from a first one of the plurality of image storage devices;
receiving and storing at least one image data from at least a second one of the plurality of image storage devices; and
rearranging and printing the stored image data on a specified position of a printing paper.

6. The printing method as claimed in claim 5, further comprising:
selecting the number of images subject to printing which is to be printed on the printing paper; and
determining whether the number of image data received and stored from at least the first and the second one of the plurality of image storage devices equals the number of images subject to printing,
wherein if the number of image data equals the number of images subject to printing, the stored image data is rearranged and printed on the specified position of the printing paper, and if the number of image data is not equal to the number of images subject to printing, the at least one image data from the first and at least the second one of the plurality of image storage devices are repeatedly received and stored until the number of images subject to printing equals the number of images subject to printing.

7. The printing method as claimed in claim 5, further comprising:
selecting one of the image data stored in one of the plurality of image storage devices as background image data; and
receiving and storing the background image data,
wherein the rearranging and printing the stored image data on the specified position of the printing paper comprises:
rearranging the stored image data; and
compositing the rearranged image data and the stored background image data.

8. A printing system comprising:
a printing device to arrange data and print data; and
a plurality of data storage devices connectable to the printing device and successively transmitting stored data directly to the printing device to be arranged and printed, wherein the data is not downloaded to an external device prior to transmitting the data to the printing device.

9. The printing system of claim 8, wherein the data is transmitted to the printing device under the control of the printing device.

10. The printing device of claim 8, wherein the data is transmitted to the printing device under the control of the data storage device.

11. The printing system of claim 8, wherein the printing device comprises:
an interface unit to connect at least one of the plurality of data storage devices to the printing device;
an input unit to set the quantity of data subject to printing from the plurality of data storage devices connectable to the printing device through the interface unit;
a memory unit to store the data from each of the plurality of data storage devices; and
a printing unit to print the stored data.

12. A printing system comprising an interface unit to receive data stored in a plurality of data storage devices connected thereto, wherein the data is received directly from each of the plurality of data storage devices, successively, and subsequently arranged and printed on specified positions of a print medium according to a user command.

13. The printing system of claim 12, wherein the data comprises image data.

14. The printing system of claim 12, wherein the data to be printed is not downloaded to an external device prior to being received by the printing system.

15. A method of arranging and printing data using a printing device having a plurality of data storage devices connectable to the printing device, the method comprising: transmitting data to the printing device from each of the plurality of data storage devices, successively, and storing the data in the printing device; and
arranging and printing the stored data on specified positions of a print medium according to a set quantity of data subject to printing, wherein the data is not transmitted to an external device prior to being transmitted to the printing device and stored.

16. The method of claim 15, further comprising:
setting the quantity of data subject to printing from the plurality of data storage devices;
transmitting the set quantity of data subject to printing directly to the printing device; and
receiving the transmitted data from each of the plurality of data storage devices, successively, and determining whether a total quantity of data received is equal to the set quantity of data subject to printing, wherein if the total quantity of data received is not equal to the set quantity of data subject to printing, then transmitting data from additional data storage devices until the total quantity of data received is equal to the set quantity of data subject to printing, and if the total quantity of data received is equal to the set quantity of data subject to printing, then arranging and printing the received data on specified positions of the print medium.

17. The method of claim 15, wherein the data is transmitted to the printing device under the control of the printing device.

18. The method of claim 15, wherein the data is transmitted to the printing device under the control of the data storage device.
